(19) United States
(12) Patent Application Publication
(10) Pub. No.: US 2009/0024724 A1
(43) Pub. Date: Jan. 22, 2009

(54) Computing System And System Management Architecture For Assigning IP Addresses To Multiple Management Modules In Different IP Configuration

(75) Inventor: Tomonori Hirai, Fremont, CA (US)

Correspondence Address: APEX JURIS, PLLC, 12360 LAKE CITY WAY NORTHEAST, SUITE 410, SEATTLE, WA, 98125, US

(73) Assignee: Tyan Computer Corporation, Taipei (TW)

(21) Appl. No.: 11/778,779

(22) Filed: Jul. 17, 2007

(51) Int. Cl. G06F 15/173

(52) U.S. Cl. 709/223

(57) ABSTRACT

A system is provided to assign IP (Internet Protocol) addresses to plural management modules under different IP modes. The system management modules are configured in a computing system that is integrated in a single chassis. All the system management modules are connected through a first management network to be assigned with a static IP address or a DHCP. Besides, a secondary system management network is used for each of the management modules to facilitate the assignment of pre-assigned private IP addresses based on the board IDs of the management modules. When DHCP mode is selected, IP configuration will be performed automatically. Namely in DHCP mode, even if the system is disconnected from the external network, the system management can be done through the system management network with the pre-assigned private IP address.

### FIELD OF INVENTION

The present invention relates to flexible IP (Internet Protocol) configuration for a computing system, and more particularly to a system management architecture for assigning IP addresses to multiple management modules in different IP configuration modes of a multi-node computing system.

### BACKGROUND

For a high-performance-calculation computing system or multi-node computing system that has multiple system management modules, such as BMC (Baseboard Management Controller) based devices integrated in a single chassis, the IP (Internet Protocol) address assignment for each of the system management modules has some problems. Generally, the assigned IP addresses are static assignments or sometimes DHCP (Dynamic Host Configuration Protocol).

In a standalone configuration without any external network connection, a typical computing system needs to assign static IP addresses to the system management modules to facilitate a system management network (such as system management Ethernet) that interconnects with the local management modules. In the other hand, for a so-called Service Processor Function of a chassis-level management module in a computing system which has multiple BMC-based devices in a single chassis, the chassis-level management module needs to assign the IP address for each BMC to use the system management network. But if the system management network is also connected to an external network, the system management network will become a non-private network and the Service Processor Function cannot assign IP address because it depends on the external network.

Please refer to FIG. 1, which illustrates a typical implementation of a computing system which has multiple BMC-based devices in a chassis. The computing system 100 may operates as a standalone system or connects to an external sever through an external network to facilitate remote management. In the computing system 100 every major modules including system management node 110, computation nodes 130, chassis management module 140 (fan, power control and etc.) or I/O modules (not shown), has a BMC 112/132/142 and uses as a (local) management module. These BMCs 112, 132, 142 connect with a system management network switch 120 to build a system management network and communicate with each other. In another word, the system management network is used for a primary system management interconnection inside a chassis of the computing system. On the system management node 110, either a service processor (not shown) or a BMC-based system management module will provide aforesaid service processor function to run specific hardware for collecting system information of each major module through the system management network.

However, there are some inconveniences and issues in this type of system. First of all, with the system management network connecting to an external network, DHCP is usually used to minimize network-related system administration. Through DHCP the computing system 100 can obtain IP addresses from an external server (not shown) via the external network. Then users do not need to assign the IP addresses manually. Nevertheless, when the computing system 100 needs to be used as a standalone system, namely not connecting to the external network, the computing system 100 cannot get any IP address from the external server. Since a typical standalone system usually uses a “static IP assignment” that assigns static IP addresses, users will have to change the system configuration when the computing system 100 is connected to the external network and set at DHCP mode.

The service processor function provided by the system management node 110 needs to know IP address information for each BMC 112/132/142 when it uses the system management network to access system information for chassis-level monitor/control. However, unless the system is completely isolated from the external network, the service processor function cannot assign each IP address by itself. It is because in the situation the IP assignments depend on the external network and each BMC might get IP address independently from the external network. Therefore it is hard for the service processor function of the system management mode 110 to retrieve such IP address information automatically.

### SUMMARY

The problems noted above are solved in large part by the present invention, which provides a system management architecture of assigning IP addresses in various IP configuration modes of a multi-node computing system.

According to the exemplary embodiment of the invention, the present invention discloses a system management architecture that mainly includes a service processing module, plural management modules, a first management network and a secondary management network. The service processing module is configured on the system management node of the computing system. The management modules are configured on the computation nodes of the computing system respectively. And the first management network connects the service processing module with each of the management modules and also connects to an external network. The secondary management network connects the service processing module with each of the management modules; wherein the service processing module assigns plural static IP addresses to each of the management modules respectively through the first management network, and assigns plural private IP addresses to each of the management modules respectively through the secondary management network. Moreover, the private IP address may be generated from a board ID of the management module or the computation node.

In accordance with the exemplary embodiment of the present invention, each of the management modules connects to a memory device that stores the static IP address and the private IP address for the corresponding management module. The memory device may includes one or more field to store the static IP address, the actual IP address, an up-link status, an IP address renew request and IP renew acknowledge.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The present invention will become more fully understood from the detailed description given hereinbelow illustration only, and thus are not limitative of the present invention, and wherein:

FIG. 1 shows an explanation diagram of system management architecture for IP address assignment of a multimode computing system in the prior art.

FIG. 2 shows an explanation diagram of a system management architecture according to the present invention, which allows assigning IP addresses to multiple management modules of a computing system in different IP configuration modes.

FIG. 3 shows another explanation diagram of system management architecture for IP address assignment of a computing system according to the present invention.

FIG. 4 shows another explanation diagram of system management architecture for IP address assignment of a computing system according to the present invention.

### DETAILED DESCRIPTION

Reference will now be made in detail to the present preferred embodiments of the invention, examples of which are illustrated in the accompanying drawings. Wherever possible, the same reference numbers are used in the drawings and the description refers to the same or the like parts.

Basically the present invention intends to improve the initialization processes for system management network under different IP configuration modes.

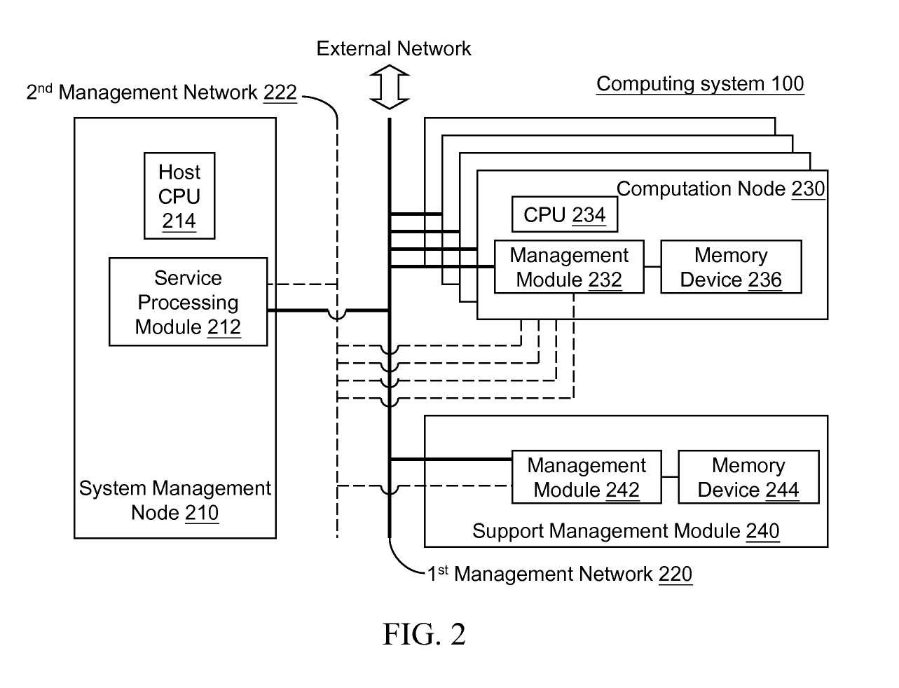

Please refer to FIG. 2, which shows an explanation diagram of a system management architecture according to the present invention. A computing system 200 has multiple nodes configured therein, including a system management node 210 and plural computation nodes 230. The system management node 210 is also called “head node” that manages all the tasks processing and operating on the whole computing system 200. And the computation nodes 230 follow the commands from the system management node 210 and process the assigned tasks.

On the system management node 210, one or more host CPU (Central Processing Unit) 214 and a service processing module 212 is configured thereon. For a clear explanation, other components such as system memory for the host CPU 214 or system bridge chipset are omitted in the drawing. The service processing module 212 is to perform the “service processing function” on the system management node 210 and the computing system 200, as mentioned in the background section. It may be realized by an integrated service processor or a BMC (Baseboard Management Controller) based system management module. The BMC mentioned in the present invention monitors/controls the system statuses and the operation performance. It collects operating parameters such as temperature, cooling fan speeds, power mode, operating system (OS) status, etc. and sends alerts to an administrator (such as the service processing module 212) or a remote host if any of the parameters indicates a potential failure of the system. Generally, the administrator can also remotely communicate with the BMC to take some corrective action through remote management links, generally IPMI (Intelligent Platform Management Interface)-based links.

On each of the computation node 230, a management module 232, one or more CPU 234 and a memory device is configured thereon. For a clear explanation, other components such as system memory for the CPU 234 or system bridge chipset are omitted in the drawing. The management module 232 monitors/controls the system statuses and the operation performance on the computation node 230. It collects operating parameters such as temperature, cooling fan speeds, power mode, operating system (OS) status, etc. and sends alerts to an administrator (such as the service processing module 212) or a remote host if any of the parameters indicates a potential failure of the computation node 230. Similarly, the management module 232 may be realized by BMC-based module.

The computing system 200 also includes a support management module 240, which manages general system support modules, such as system fans, power supplies, specific system sensors and etc. This integrated support management module 240 is an optional module and not essential for the computing system 200. However, whit a management module 242 configured therein, the support management module 240 may also be monitored and controlled by the service processing module 212 of the system management node 210.

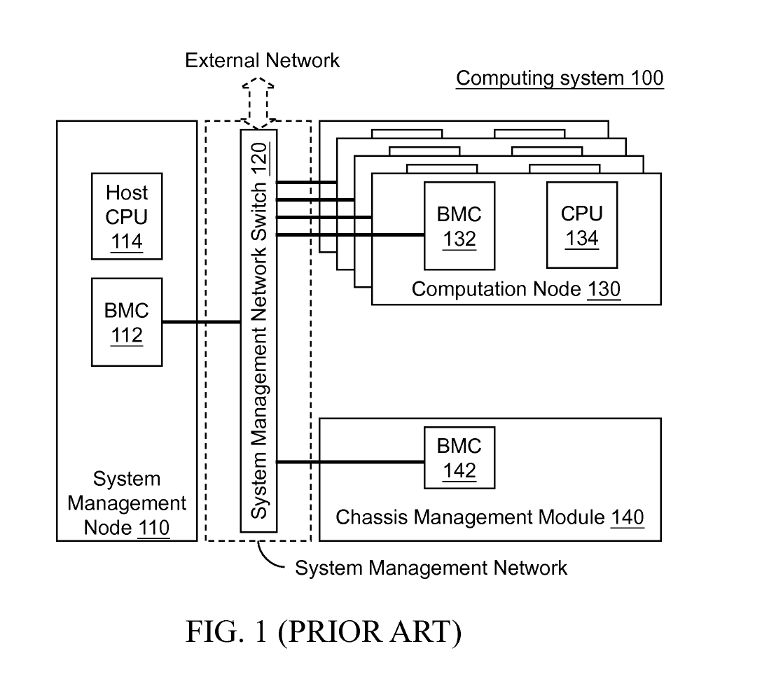

A first management network 220 of the computing system 200 is used to connect the service processing module 212 on the system management node 210 with all the management modules 232, 242 on the computation node 230 and the support management module 240. The first management network 220 is compatible with IPMI specification. Through the first management network 200, the service processing module 212 and/or the management module 232, 242 may be connected with the external network to communicate with a remote host (not shown). In some cases, the first management network 220 may be realized by a system management network switch (not shown) plus IPMI-compatible system management buses (not marked). The system management network switch is to provide up-link port for an external network connection, as disclosed in FIGS. 1 and 2; namely, the first management network 220 connects the external network through the network switch.

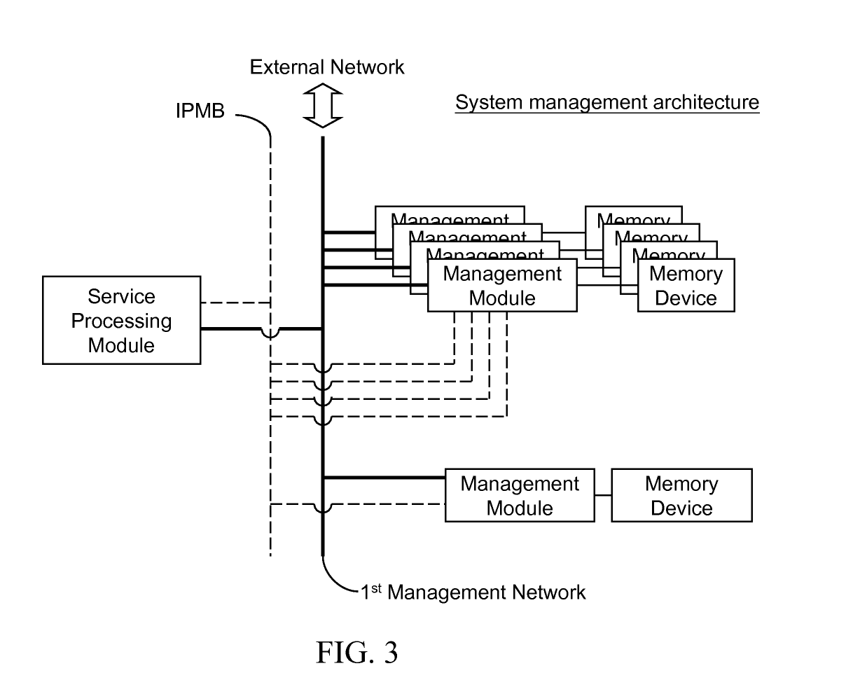

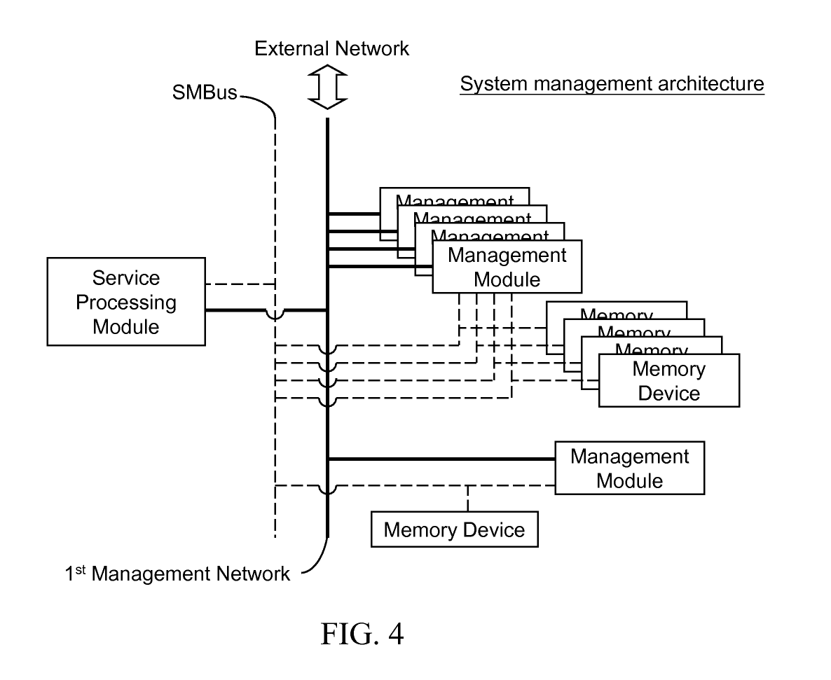

Meanwhile, a secondary management network 222 is also used to connect the service processing module 212 on the system management node 210 to all the management modules 232, 242 on the computation node 230 and the support management module 240. The secondary management network 222 is an IPMI-based internal network without connecting to the external network. It is to collect information for system management network configuration. Two embodiments of the present invention disclose two types of bus applications, including Intelligent Platform Management Bus (IPMB) in FIG. 3 and SMBus (System Management Bus) in FIG. 4.

To facilitate a flexible Internet Protocol (IP) configuration, memory devices 236, 244 are configured to respectively connect with the management modules 232, 242 on the computation nodes 230 and the support management node 240. The memory devices 236, 244 are used to store different IP addresses corresponding to different IP configuration modes. Except independently and connected to the management modules 232, 242, the memory devices 236, 244 may possibly be embedded respectively in the management modules 232, 242. In each of the memory devices 236, 244, the following information fields for system management network configuration are used therein for various network informations:

(1) Field of Static IP Address: In a static IP mode, the static IP addresses for each of the management modules 232, 242 of the computation nodes 230 and the support management module 240 may be stored as formerly assigned, or be assigned by the service processing module 212 during the initialization process of the management modules 232, 242. In some cases that the memory devices 236, 244 stores a strange number, such as “255.255.255.255” which is not usually used for an IP address, the IP configuration modes will be changed to a DHCP Mode (Dynamic Host Configuration Protocol) and the management module 232 will need to send a request to get an DHCP IP address from an external server.

(2) Field of Actual IP Address: Each of the management modules 232, 242 needs to store an actual IP Address for the management module 232 or 242, either a static IP address or a DHCP IP address. The service processing module 212 will read this field in each of the memory devices 236, 244 to access the stored actual IP address and collect IP address information of each of the management modules 232, 242. The DHCP IP address retrieved from the external sever may be assigned to each of the management modules through the service processing module or directly to each of the management modules.

(3) Field of Up-link Status: This is to indicate the status of the up-link port on the system management network switch; namely this field stores an up-link status between the first management network and the external network. Service processing module 212 will set the up-link status in the corresponding memory devices 236, 244 if the up-link port is established a link already. If this up-link status indicates not linked and the IP address mode remains DHCP, namely all the system management networks are isolated from the external network, then the management module 232, 242 will use a pre-assigned “private IP address” generated from a board ID (identification) of each of the management modules 232, 242, or, generated from the board ID of each the computation nodes 230 and the support management module 240 respectively. For example, “192.168.xxx[board ID]” is a typical private IP address.

(4) Field of IP Renew Request: This is a field for Service Processing Module 212 to set IP address renew request. The Service Processing Module 212 needs to poll or check the link status of the up-link port on the system management network switch. If the service processing module 212 finds a transition from “not linked” to “linked”, the service processing module 212 will set this field to request each of the management modules 232, 242 to renew its IP address. Each of the management modules 232, 242 will renew its IP address based on this field if acknowledge filed is not set. This field will be read only by BMC to avoid race condition. If this field is cleared and the field of IP Renew Acknowledge is still set, the management module 232 or 242 will need to clear the field of IP Renew Acknowledge.

(5) Field of IP Renew Acknowledge: This is to indicate acknowledge for IP address renewal. After renew operation has been done, BMC or the management module will set this acknowledge field to tell Service Processing Module 212 that the renew operation is finished. Then Service Processing Module 212 will clear the IP renew request field of the memory device 236, 244 to avoid unexpected renewal.

The system management node 210 may also have a similar memory device configured independently thereon or embedded in the service processing module 212, thereby to store related informations about system management network configuration.

Besides, in the present invention each of the system management node 210, computation nodes 230 and support management module 240, or each of the management module 232, 242 has an unique board ID to generate pre-assigned private IP address when the system management network is isolated from the external network. To facilitate a DHCP IP mode, each of the management modules in the present invention needs to have certain firmware that supports DHCP IP configuration.

The following table indicates IP address policy in this invention. There are three types of IP address assignment scheme:

(1) Static Assignment: This is highest priority of assignment. The computing system 200 always uses static IP address for each of management module 232, 242 whenever it is available.

(2) DHCP IP Assignment: If the field of static IP address in the memory device 236 or 244 is a strange address (such as 255.255.255.255 which has never used as IP address), then system will use DHCP IP address assigned by the external sever. The DHCP Assignment is provided through the first management network.

(3) Private IP Assignment: When the system is configured as DHCP mode, but the system is not connected with the external network, then the system can use pre-assigned private IP address based on the board ID. The private IP address is assigned through the secondary management network.

To switch between different IP address type, the management module and Service Processing Module of the present invention need to monitor some statuses, such as up-link status, IP address mode and etc.

| | Field of | | Up-link | Assigned |
|---|---|---|---|---|
| | Static IP Address | DHCP | Status | IP Address |
| Static | (1)Strange IP Address | Enable | Linked | DHCP IP address |
| IP | | | or Not | |
| Mode | (2)Others | Disable | Linked | Static IP address |
| | | | or Not | |
| DHCP | Strange IP Address | Enable | Linked | DHCP IP address |
| Mode | | Enable | Not | Private IP address |
| | | | Linked | based on Board ID |

The followings indicate DHCP renewal and IP address invalidate policy based on system status.

(1) Event 1: Initialization (Initial Power-Up process for each management module)

Response: Clear the field of Actual IP address in the memory device. Store static IP address or assigned DHCP IP address to the field of Actual IP address.

(2) Event 2: Link for management module (“Linked” transferring to “Not Linked”)

Response: If it is DHCP mode, clear actual IP address. (System Management Network cannot be used, since link is down)

(3) Event 3: Link for management module (“Not Linked” transferring to “Linked”)

Response: If it is DHCP mode, Renew IP addresses. Service Processing Module will need to poll this Field of IP Renew Request.

(4) Event 4: Up-link (“Linked” transferring to “Not Linked”)

Response: If it is DHCP mode, clear the actual IP address (invalidate); and then use pre-assigned private IP address based on the board ID.

(5) Event 3: Up-link (“Not Linked” transferring to “Linked”)

Response: If it is DHCP mode, Renew IP address. Service Processing Module needs to set IP Renew Request. Management module needs to set Field of IP Renew Acknowledge after renewed.

In conclusion, the present invention discloses a system management architecture for assigning a plurality of IP addresses in a computing system that has a system management node and a plurality of computation nodes. The system management architecture basically includes a service processing module, plural management modules, a first management network and a secondary management network. The service processing module is configured on the system management node of the computing system. The management modules are configured on the computation nodes of the computing system respectively. And the first management network connects the service processing module with each of the management modules and also connects to an external network. The secondary management network connects the service processing module with each of the management modules; wherein the service processing module assigns plural static IP addresses to each of the management modules respectively through the first management network, and assigns plural private IP addresses to each of the management modules respectively through the secondary management network.

Besides, in come cases of the present invention, each of the management modules connects to a memory device that stores the static IP address and the private IP address for the corresponding management module. Moreover, the private IP address may be generated from a board ID of the management module or the computation node.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A system management architecture for assigning a plurality of IP (Internet Protocol) addresses in a computing system that has a system management node and a plurality of computation nodes, the system management architecture comprising:
a service processing module configured on the system management node of the computing system;
a plurality of management modules configured on the computation nodes of the computing system respectively;
a first management network connecting the service processing module with each of the management modules and connecting to an external network; and
a secondary management network connecting the service processing module with each of the management modules;
wherein the service processing module assigns a plurality of static IP addresses to each of the management modules respectively through the first management network, and assigns a plurality of private IP addresses to each of the management modules respectively through the secondary management network.

2. The system management architecture of claim 1, wherein each of the management modules connects to a memory device that stores the static IP address and the private IP address for a corresponding one of the management modules.

3. The system management architecture of claim 2, wherein at least one of the memory devices comprises a field that stores the static IP address for the corresponding one of the management module.

4. The system management architecture of claim 2, wherein at least one of the memory device comprises a field that stores an actual IP Address for the corresponding one of the management module.

5. The system management architecture of claim 2, wherein at least one of the memory devices comprises a field that stores an up-link status between the first management network and the external network.

6. The system management architecture of claim 2, wherein at least one of the memory device comprises a field that allows the service processing module to set an IP address renew request.

7. The system management architecture of claim 2, wherein at least one of the memory device comprises a field of IP renew acknowledge that allows the management module to set for indicating that the renew operation is finished.

8. The system management architecture of claim 1, wherein at least one of the private IP addresses is generated from a board ID (identification) of a corresponding one of the management modules.

9. The system management architecture of claim 1, wherein at least one of the private IP addresses is generated from a board ID (identification) of a corresponding one of the computation nodes.

10. The system management architecture of claim 1, wherein a DHCP (Dynamic Host Configuration Protocol) IP address is retrieved from an external sever to the management module via the external network.

11. The system management architecture of claim 10, wherein the DHCP IP address is assigned to each of the management modules through the service processing module, or assigned directly to each of the management modules.

12. The system management architecture of claim 10, wherein the DHCP IP address is assigned through the first management network.

13. The system management architecture of claim 1, wherein the computing system further comprises a support management module that has another management module, the service processing module assigning another static IP address to the management module on the support management module through the first management network.

14. The system management architecture of claim 13, wherein the service processing module assigns another private IP address to the management module on the support management module through the secondary management network.

15. The system management architecture of claim 1, wherein the first management network comprises a system management network switch and at least one IPMI-compatible system management bus.

16. The system management architecture of claim 15, wherein the first management network connects with the external network through the network switch.

17. The system management architecture of claim 1, wherein the secondary management bus is compatible with IPMB (Intelligent Platform Management Bus).

18. The system management architecture of claim 1, wherein the secondary management bus is compatible with SMBus (System Management Bus).

19. The system management architecture of claim 1, wherein the service processing module is an integrated service processor or a BMC (Baseboard Management Controller) based system management module.

20. The system management architecture of claim 1, wherein the management module is a BMC based system management module.
